(19) United States
(12) Patent Application Publication
(10) Pub. No.: US 2011/0220436 A1
(43) Pub. Date: Sep. 15, 2011

(54) Fall Protection System

(76) Inventor: Stephen Green, Queensland (AU)

(21) Appl. No.: 13/119,798

(22) PCT Filed: Sep. 18, 2009
(86) PCT No.: PCT/AU2009/001240

§ 371 Date: May 27, 2011

(30) Foreign Application Priority Data
Sep. 19, 2008 (AU) 2008904893

(51) Int. Cl. A62B 1/08; A62B 1/12; F16D 59/00; A62B 1/10

(52) U.S. Cl. 182/232; 182/231

(57) ABSTRACT

A fall protection system comprising a line wound onto a rotatable pulley having a centrifugal clutch which activates a gearbox which in turn drives an input shaft of a hydraulic actuator whereby the hydraulic actuator controls the rate of rotation of the pulley, and a secondary brake which slows the rotational speed of the pulley should it exceed a predetermined speed, whereby in use, the line is attached to a user to restrain a fall and then the system facilitates unwinding of the line at a controlled speed to effect descent.

### INTRODUCTION

This invention relates to a personal fall protection system and, in particular, relate to systems which have a dual role of arresting a fall whilst providing facility for vertical descent and self rescue after an arrested fall.

### BACKGROUND OF THE INVENTION

There have been many suggestions to minimise the injury of a person falling from a substantial height. This is a particular problem in the construction, heavy manufacturing, off-shore oil and gas, and aircraft and mining vehicle maintenance industries where personnel are exposed to the hazard of a fall to either a lower level or ground level. Statutory regulations now limit fall exposures to generally 2 metres before mandating a means of fall protection or prevention. Given the potential differences in height that arise in the aforementioned industries, fall hazard control is a frequent need. One solution to this problem is attaching the individual to a harness that is connected to a fall arrestor that is secured to the building via a certified anchor point. In the event that a person falls, a life line is unwound from a spool through a braking system which suddenly locks, leaving the person dangling in a harness while at the end of the fall arrestor line. Whilst devices of this kind save lives because they prevent the person from falling to the ground, they still suffer from the problem that the fact that the person remains dangling from the arrestor line is in itself dangerous and there is the need to then use some other safety equipment and personnel trained in emergency rescue to reach the person so that the person can be lowered to the ground. Tests with personnel in situations where they are suspended in a harness show the slow to rapid onset (depending on individual susceptibility) of decreased cardiac, respiratory and circulatory function. The concern is that these effects can be life threatening and the required response of employers and users of fall arrest systems in general, is to have a rescue plan capable of being effected “promptly” after a fall. This can be complicated because the means of accessing a fallen worker may involve a rope rescue, high angle ladder rescue or other class of specialised access. The common features of these rescue modes are that they all involve a degree of risk to both the rescuers and the rescuee and require a trained team of emergency response personnel on hand to implement. Suspension trauma onset periods as low as 3 to 5 minutes have been quoted in the literature.

A typical fall arrestor is disclosed in patent application WO 97/47359.

In our earlier International patent applications PCT/AU2003/00852 and PCT/AU2005/001329 we disclosed a descent apparatus in which one end of a cable is anchored at an elevated location and the other end is wound around a pulley apparatus that is connected to the person or load from which the cable unwinds at a controlled rate as the person or load descends from the elevated location.

This invention relates to the combination of the descent apparatus of the kind described above with a fall arrestor so that the device can be securely attached to the building and the line can be attached to the person via a suitable harness. The fall arrestor allows a certain degree of line to be unwound from the arrestor allowing the person to move about the building. However, should the person fall, the fall arrestor locks and following a pre-set time period, automatically lowers the person to the ground through use of the descent apparatus.

### SUMMARY OF THE INVENTION

According to one aspect of the present invention there is provided a fall protection system comprising a line wound onto a rotatable pulley having a centrifugal clutch which activates a gearbox which in turn drives an input shaft of a hydraulic actuator whereby the hydraulic actuator controls the rate of rotation of the pulley, and a secondary brake which slows the rotational speed of the pulley should it exceed a predetermined speed, whereby in use, the line is attached to a user to restrain a fall and the system then facilitates unwinding of the line at a controlled speed to effect descent.

### DESCRIPTION OF THE DRAWINGS

An embodiment of the present invention will now be provided by way of example only with reference to the accompanying drawings in which:

FIG. 1 is a side elevational view of a restraint and descent apparatus;

FIG. 2 is a cross-sectional view of the restraint and descent apparatus;

FIG. 3 is a side elevational view of a centrifugal clutch plate forming part of the clutch component of an epicyclic gear train forming part of the apparatus;

FIG. 4 is a sectional view of the epicyclic gear train;

FIG. 5 is a side elevational view of a hydraulic actuator and drive shaft which forms part of the apparatus;

FIG. 6a is a cross-sectional view of a mechanical seal assembly and sun gear shaft which is housed within the open side of the hydraulic actuator;

FIG. 6b is an end elevational view of internal hydraulic gears of the actuator;

FIG. 7a is a side elevational view of an open side housing of the hydraulic actuator;

FIG. 7b is an end elevational view viewed from the interior of the housing;

FIGS. 7c and 7d are end elevational views of the housing when viewed from the exterior;

FIGS. 8a and 8d are side elevational views of the closed side of the actuator housing with integral shaft;

FIG. 8b is an end elevational view of the housing viewed from the interior;

FIG. 8c is an end elevational view of the housing viewed from the exterior;

FIGS. 9a and 9d are side elevational views of a central housing of the hydraulic actuator;

FIG. 9b is an end elevational view of the housing viewed from the arrow C;

FIG. 9c is an end elevational view of the housing viewed in the direction of the arrow B;

FIGS. 10a and 10b are end elevational views of the open side and closed side housing showing the locations of hydraulic valve assemblies;

FIG. 10c is a side elevational view of a pressure release valve assembly in the form of a counter balance valve;

FIG. 10d is a side elevational view of an internally mounted burst disc as an alternative to the pressure release valve;

FIG. 10e is a side elevational view of a selector valve assembly for transition control between arrest and descent modes;

FIG. 10f is a side elevational view of a hydrostat valve assembly;

FIG. 11 is a schematic circuit of the hydraulic circuit incorporating the burst disc; and

FIG. 12 is a cross-sectional view taken along the lines 12-12 of FIG. 2 showing a centrifugal brake.

### DESCRIPTION OF THE PREFERRED EMBODIMENT

The restraint and descent apparatus 10 shown in the accompanying drawings essentially comprises a two part housing 11, 12 which contains a pulley 15 on which is wound a wire rope W. At slow speeds, the pulley 15 is free to rotate against a flat coil spring 9 located within a cavity of the housing part 11 to provide a gentle back tension in the wire rope W. At higher speeds, such as can occur within 600 mm of a free fall, a centrifugal clutch 80 is activated to engage a hydraulic actuator 50 housed within the centre of the pulley 15. The actuator 50 controls rotation of the pulley 15 via an epicyclic gear train 90.

In use, the wire rope W is attached to a harness worn by the user of the apparatus in a manner that it can be unwound from the pulley 15, against the spring 9 under low rope tension and at low speeds. This allows the user to move about relative to the apparatus whilst attached to the apparatus by the length of wire rope W. Should the user fall, the sudden acceleration of the wire rope W causes the centrifugal clutch 80 to lock which in turn transmits the rotation of the pulley 15 to the epicyclic gear train 90. The output of the epicyclic gear train 90 then drives the hydraulic actuator 50 which substantially reduces the rotational speed of the pulley 15 and allows the rope W to unwind at a controlled speed effecting descent of the user. The coil spring 9 has the inside diameter clamped to the housing 11 and the outside diameter riveted to a guide 8 that is bolted to the pulley 15. As the pulley 15 rotates to unwind the wire rope W, the flat coil spring 9 is tensioned throughout the descent so that when the user descends to the ground the wire rope can be disconnected and then wound back onto the pulley 15 through the force of the coil spring. A spring shock absorber (not shown) is provided on the end of the wire rope W to absorb the shock that would otherwise be induced as the clasp meets the housing 11, 12.

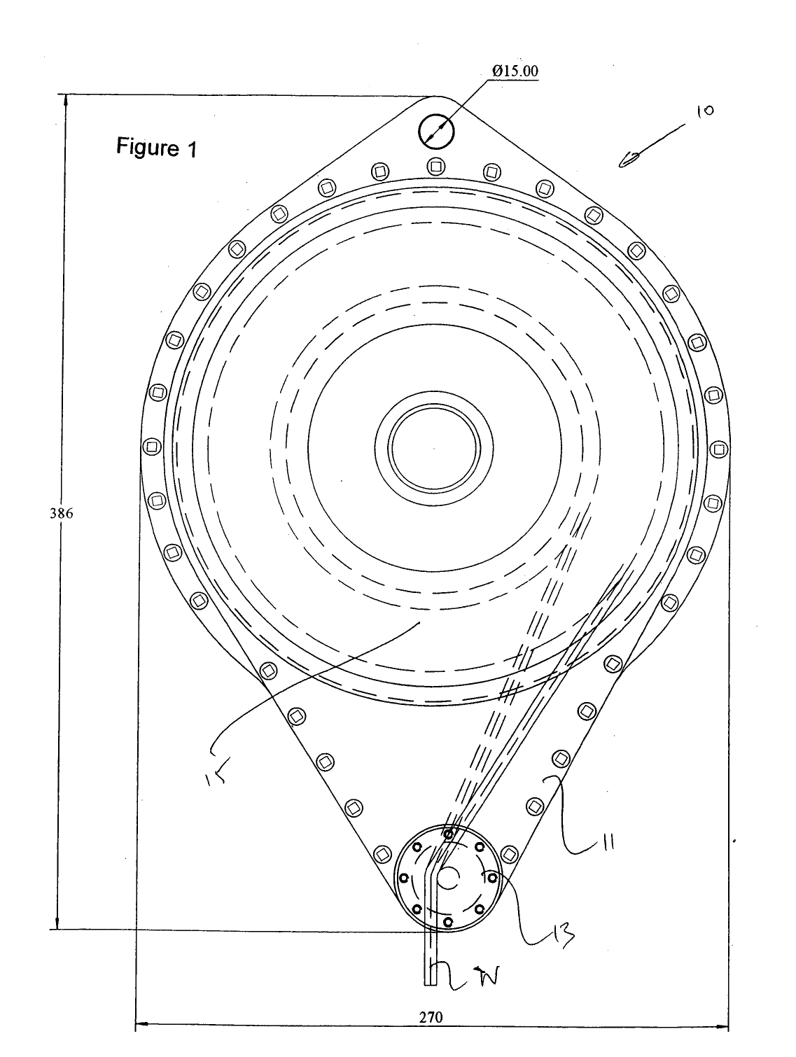

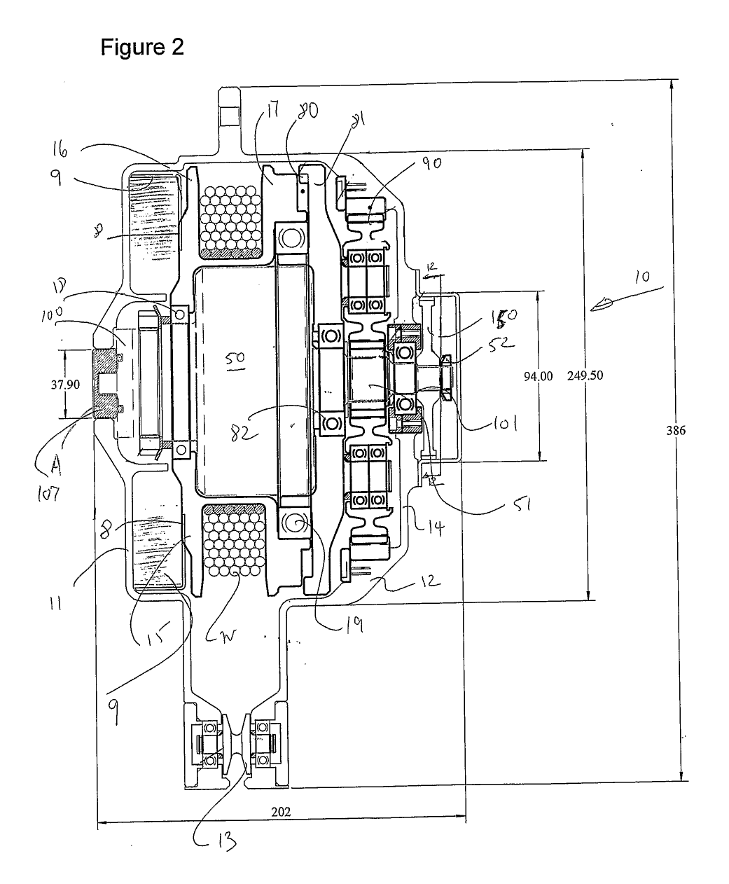

As shown in FIG. 2, the pulley 15 sits substantially centrally of the housing halves 11, 12 and the hydraulic actuator 50 is located within the centre of the pulley 15. On the right hand side of the hydraulic actuator there is a projecting shaft 51 which supports the centrifugal clutch 80 and epicyclic gear train 90. That same shaft 51 also supports an over-speed centrifugal brake 150 which provides secondary braking to the braking provided by the actuator 50. The wire rope W is fed from the pulley 15 through an idler pulley 13 at the base of the unit to extend out of the underside of the unit as shown in FIG. 1.

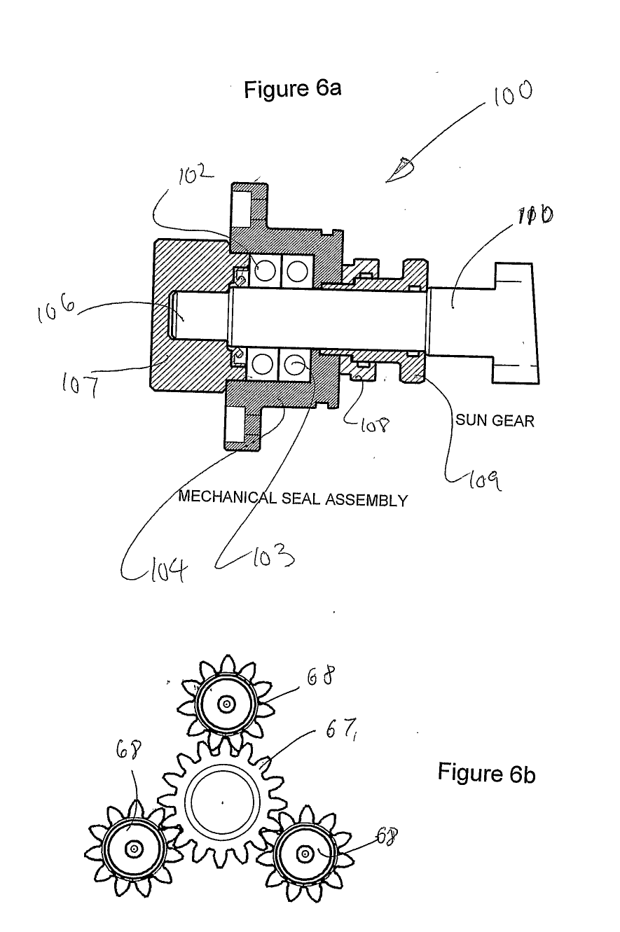

As shown in FIGS. 1 and 2, the housing is cast and machined in two halves 11, 12 to be bolted together as shown in FIG. 1. The housing defines a substantially circular enclosure with a central axis. The pulley 15 having spaced radial flanges 16, 17 is located within the housing and is mounted to rotate on bearings 18, 19 located on the external inner and outer sides of the hydraulic actuator 50. The pulley 15 supports a stainless steel wire rope W, preferably of 5.6 mm to 6.0 mm diameter, tensile strength exceeding 16 kN, and typically 16 metres to 20 metres in length, with other lengths possible depending on the application fall distance. The hydraulic actuator 50 is supported at one side about a mechanical seal assembly 100 shown in FIG. 6 and is supported at the other side by the shaft 51 about bearings 101 located in an end flange 14 on the front face of the housing 12.

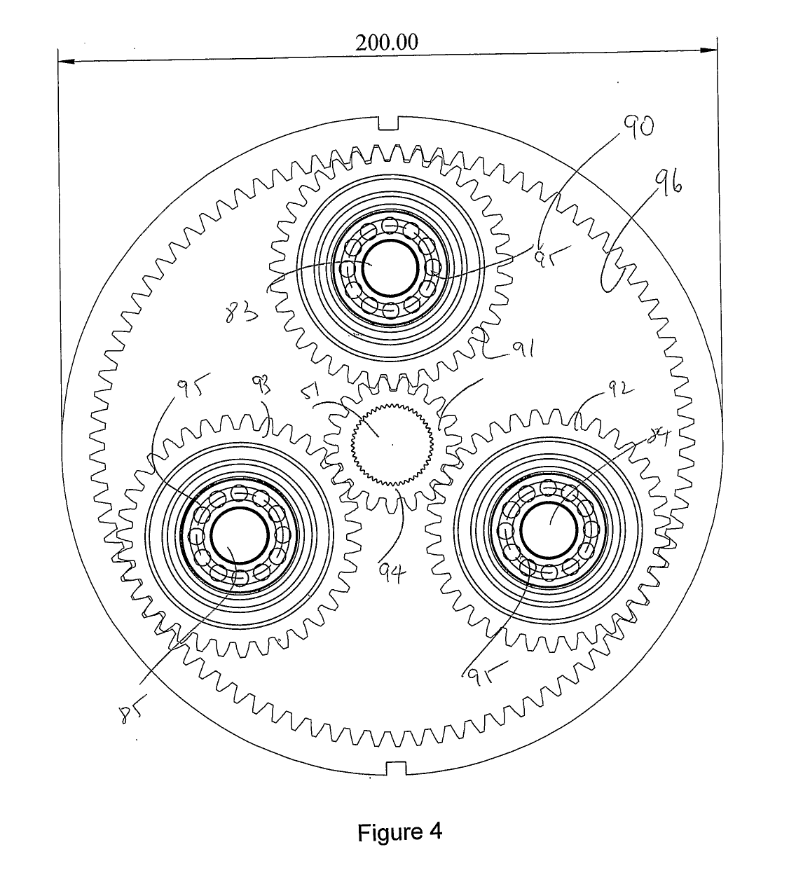

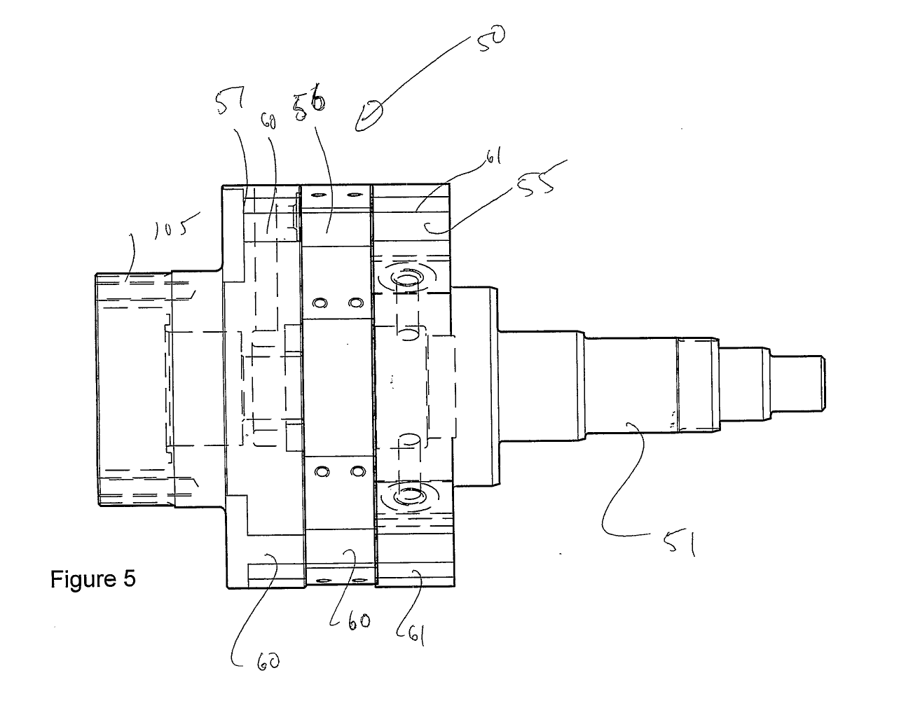

As shown in FIG. 5, the outer side of the hydraulic actuator 50 has the stepped shaft 51 which projects axially therefrom and is arranged to support the centrifugal clutch 80, the epicyclic gear train 90, the bearings 101 and the over-speed centrifugal brake 150. The end of the shaft 51 is held within the casing by a nut 52 shown in FIG. 2.

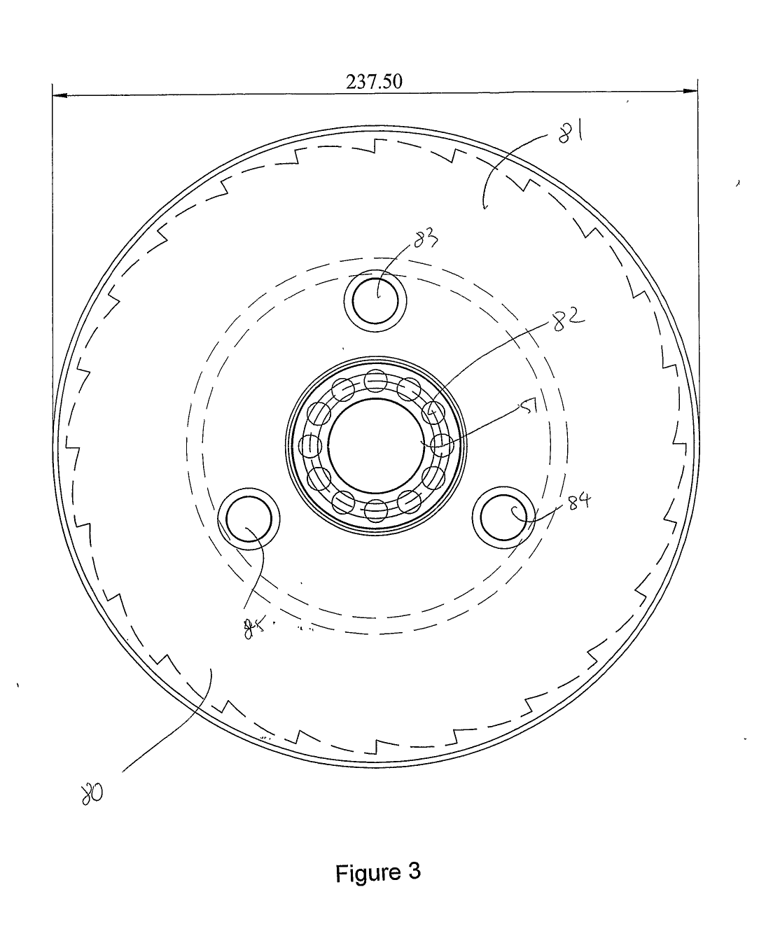

At low speeds, the pulley 15 freewheels (with applied spring 9 back tension) about the hydraulic actuator 50 on the bearings 18, 19 but as the speed increases, the centrifugal clutch 80 engages to cause the pulley 15 to drive the centrifugal clutch plate 81 which in turn constitutes the driving arm of the epicyclic gear train 90. As shown in FIG. 3, the clutch plate 81 is rotatable about the shaft 51 on bearings 82 and supports three equally spaced shafts 83, 84, 85 that support planetary gears 91, 92, 93 which are freely rotatable about bearings 95. As shown in FIG. 4, the rotation of the driving arm 81 of the epicyclic gear train 90 causes the three equally spaced planetary gears 91, 92, 93 to rotate about a fixed annular gear 96 which is secured to the housing 12. The rotation of the planetary gears 91, 92, 93 about the fixed annular gear 96 causes axial rotation of each planetary gear which in turn meshes with a central sun gear 94 that is splined to the shaft 51 to thus cause rotation of the shaft 51 and in turn rotation of the hydraulic actuator 50. The epicyclic gear train 90 can be designed to cover a range of speed ratios, however the optimum ratio (speed-pulley: speed-actuator) for minimising the important parameters of centrifugal brake diameter, hydraulic gear pitch diameter and internal hydraulic fluid velocity/port size is between 1:5.50 and 1:6.50. The present embodiment provides for an epicyclic gear ratio of between 1:5.89 to 1:6.15.

The input shaft 51 on the right hand side of the assembly as shown in FIG. 2 is driven by the pulley 15 through the centrifugal clutch 80 and epicyclic gear train 90. The hydraulic actuator 50 operates to retard the rotation speed of the input shaft 51 and thus control the rate of descent over a person attached to the wire rope W which is being unwound from the pulley 15.

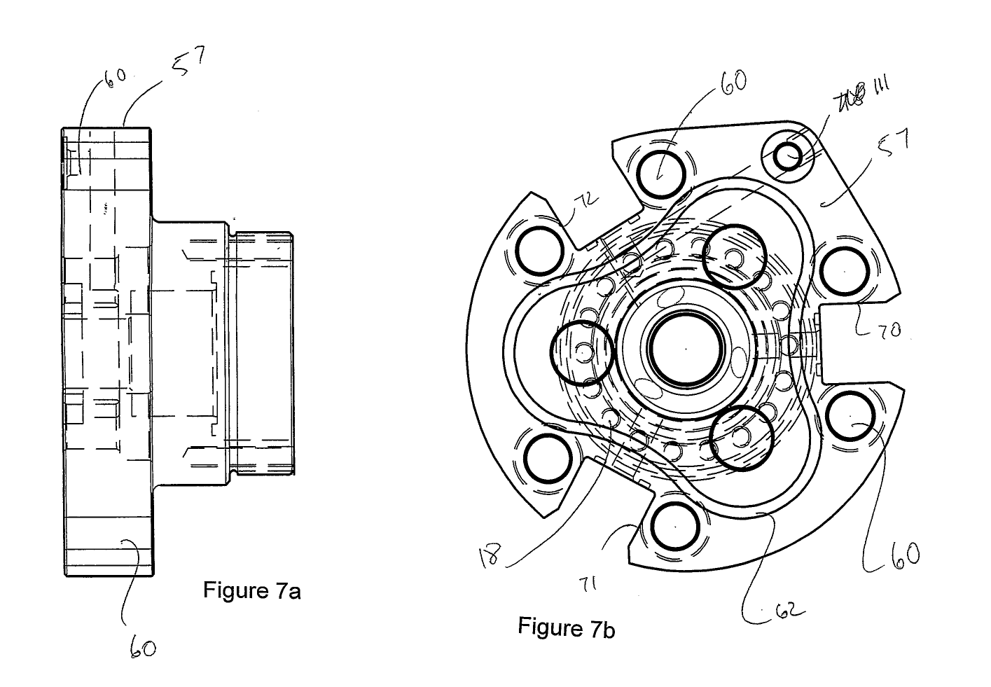

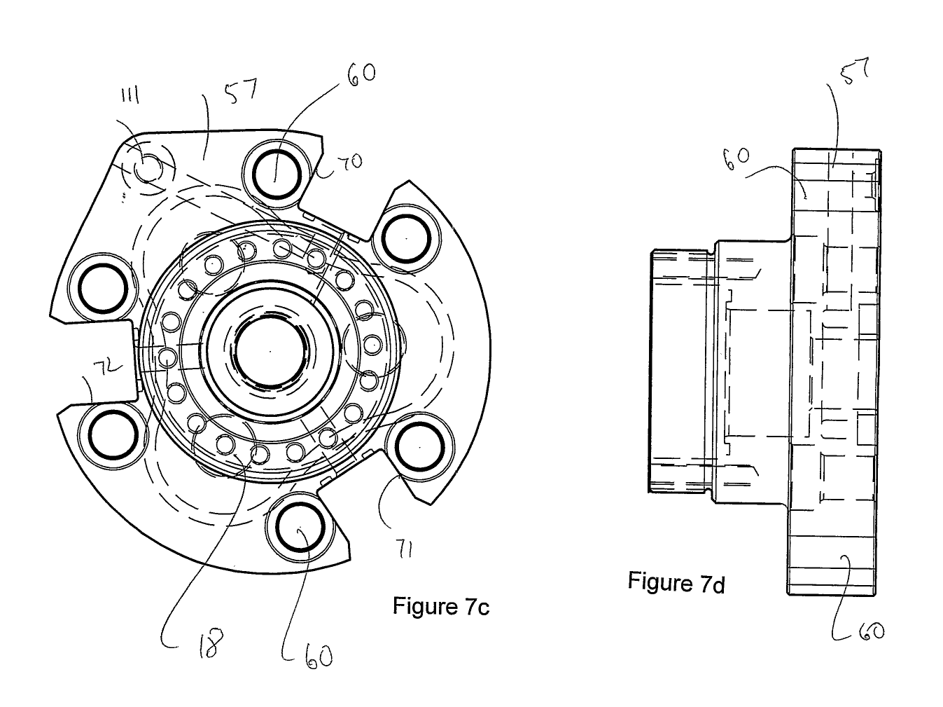

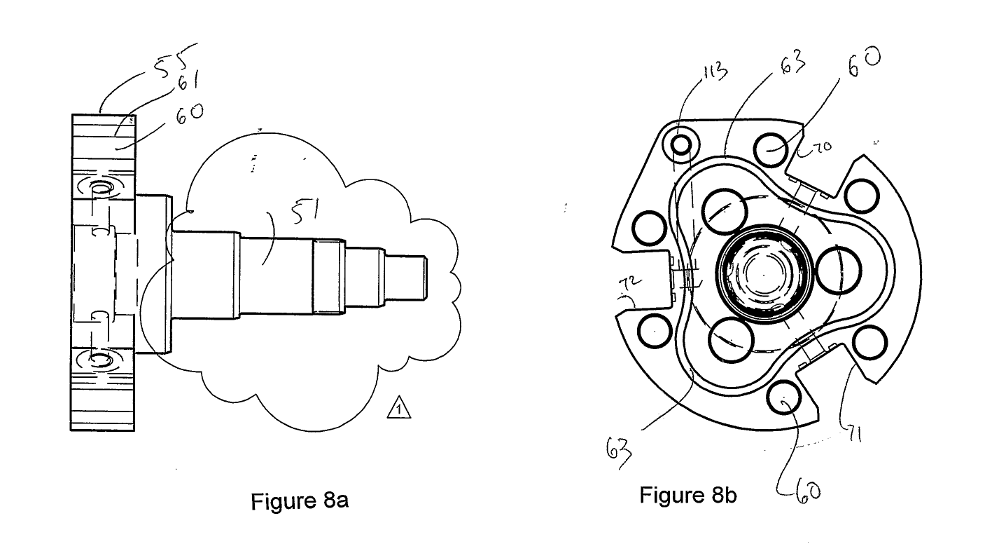

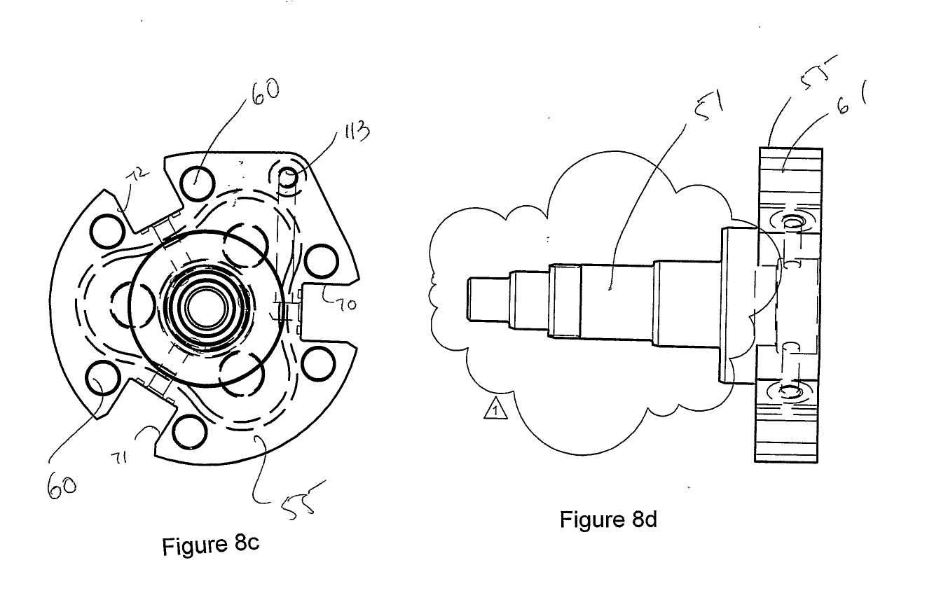

The hydraulic actuator 50 is illustrated with particular reference to FIGS. 5 to 10. The hydraulic actuator 50 comprises a substantially cylindrical assembly of three housings 55, 56, 57, namely a closed side housing 55 which integrally supports the input shaft 51, a central housing 56 and an open side housing 57 which supports the mechanical seal assembly 100 (FIG. 6a) which is in turn located against the face of the housing 11 of the device 10 (FIG. 2). The closed side housing 55 is the high pressure side of the hydraulic actuator 50 whilst the open side housing 57 is nominally the low pressure side.

The three housings 55, 56, 57 are bolted together through bolts (not shown) extending through six equally spaced apertures 60 in the periphery of the housings to engage internally threaded holes 61 in the closed side housing 55. The central housing 56 is thus clamped between the closed side and open side housings 55, 57 by the bolts and the assembly is sealed via O-rings 62, 63 which are located in clover-leaf shaped grooves in the closed and open side housings.

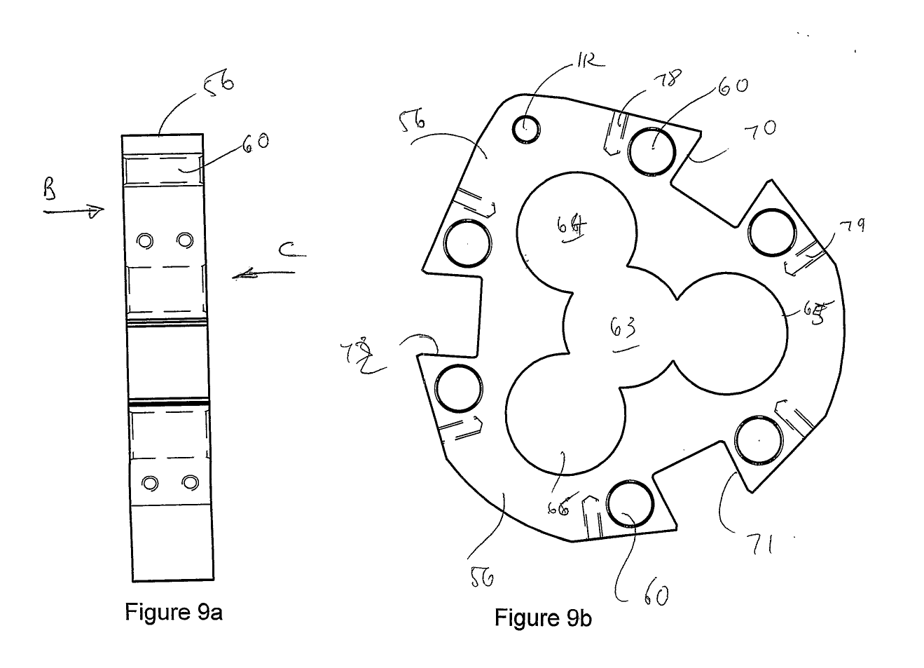

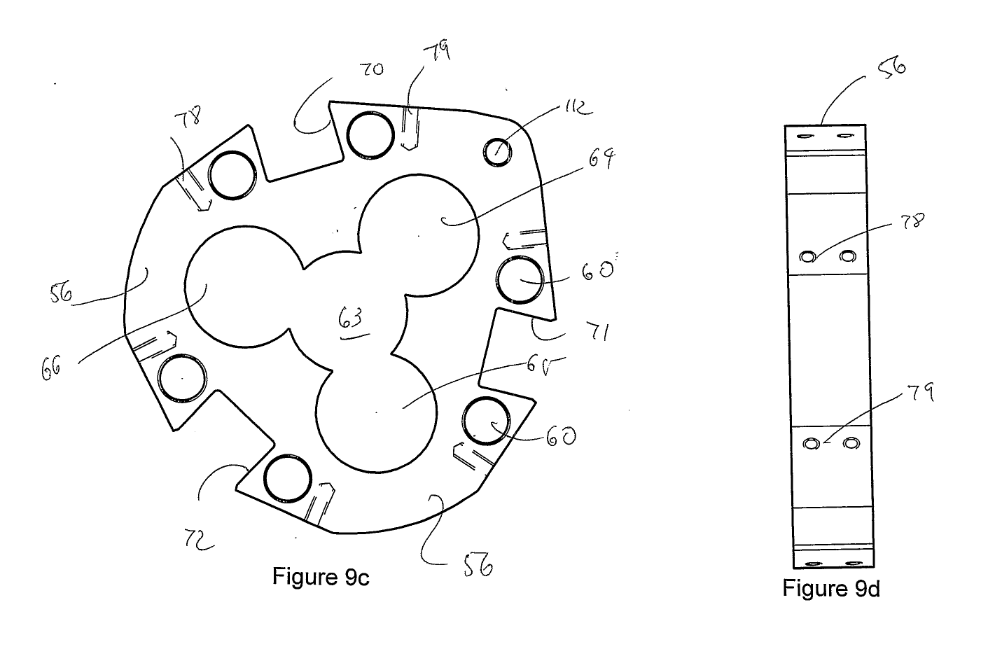

The central housing 56 shown in FIG. 9 has a central aperture 63 which houses a sun gear 67 and three equally spaced radial apertures 64, 65, 66 which in turn house planetary gears 68 of the same or smaller diameter as the sun gear, see FIG. 6b. Rotation of the hydraulic actuator housing due to rotation of shaft 51 causes the shafts of the planetary gears to rotate about the central axis which because the planet gears 68 all mesh with the single sun gear 67, forces simultaneous and coordinated motion of the aforementioned planetary gears. Rotation of the whole housing causes the planetary gears 68 to rotate about the sun gear 67 which is in turn journaled for rotation about the mechanical seal assembly 100. The internal sun gear 67 and planetary gears 68 have the effect of pumping oil from one side to the other and back again through the three externally mounted valve assemblies. The arrangement effectively defines three sets of combined gear pumps which operate to provide balanced thrust around the sun gear. They also provide the greatest mechanical leverage available within the limited space requirements and hydraulically treble the flow capacity. This permits the design of a gear pump unit within the hydraulic actuator that provides balanced forces and a very significant reduction otherwise extremely high operating pressures to handle the peak loads of arresting a fall. For the typical size in the current embodiment, peak pressures in arresting a fall are expected to reach 350 bar with descent pressures reaching 80 bar.

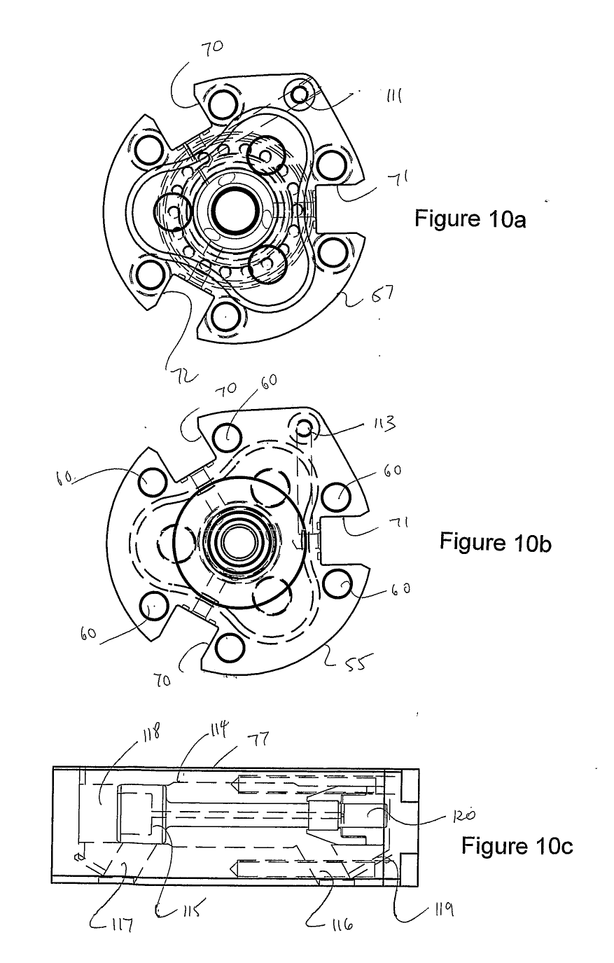

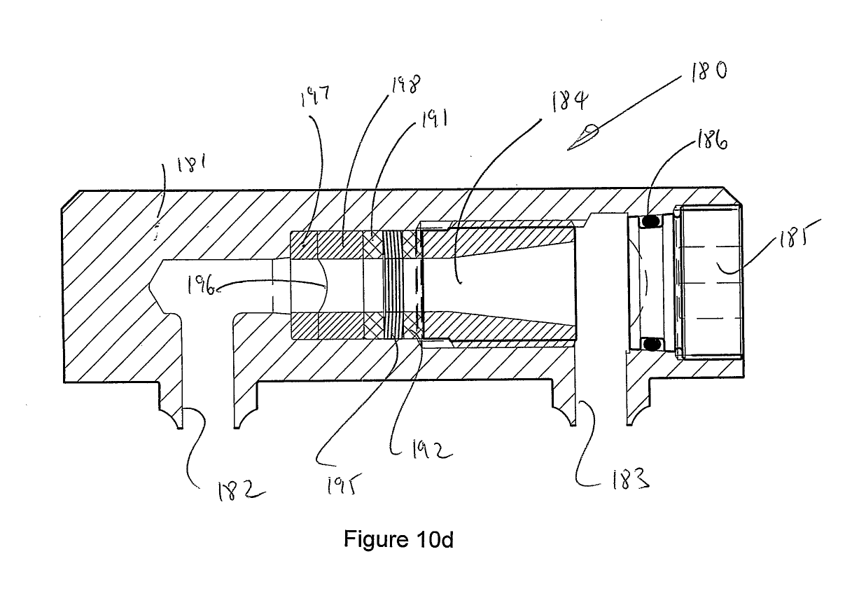

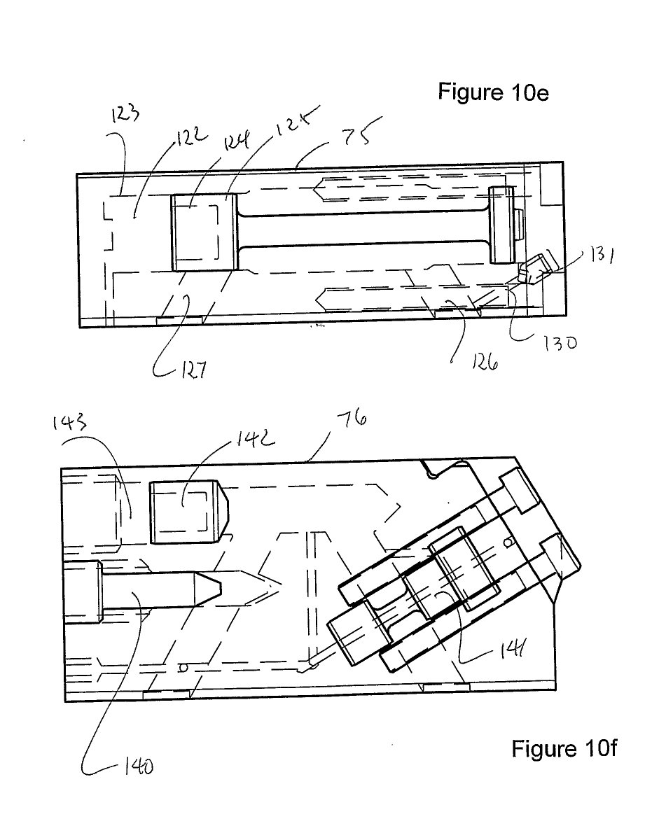

FIGS. 10a, 10e and 10f show the three hydraulic valves 74, 75, 77 which fit into the open side and closed side housings 57, 55. As the hydraulic actuator housings 55, 56, 57 rotate, the planetary gears (not shown) separate from the sun gear (not shown) on one side of the gear mesh and close on the other side. The tooth spaces in both the sun gear and planetary gears capture the hydraulic fluid and drag it away from opening side of the gear mesh, forcing it into the closing side of the gear mesh. For the opening side of the gear mesh, hydraulic fluid is received from an annular cavity in the low pressure side housing 57. Fluid enters this cavity because it has been forced through either of the pressure relief valve 77 or the flow control valve 76. Fluid can not enter the low pressure cavity from the selector valve 75. Fluid squeezed on the closing side of the gear mesh is forced into a similar cavity in the closed side housing 55. From this cavity the fluid can flow to either the pressure relief valve 77 (or burst disc in lieu of a spool valve) or the selector valve 75. Fluid cannot flow from the high pressure cavity to the flow control valve 76 directly. To complete the flow loop for speed control, fluid has to flow from the high pressure cavity to the selector valve 75, then from this valve into ports 111 drilled into the open side housing 57. This port 111 is labeled “flow cross over port” in FIG. 10a. The fluid then flows through a matching port 112 in centre plate 56 and into a flow port 113 in the closed side housing 61. It is important to note that port configurations between housings 55 and 57 are asymmetrical. This port configuration has been purposely designed to permit fluid which flows through the arrest/descent selector valve 75 to not bypass the flow control valve 76. For this to occur the flow path can not intersect a fluid cavity more than once. Hence the port arrangement in the housing permits both the selector valve 75 and flow control valve 76 to operate in series, whereas the pressure regulating valve 77 operates in parallel to both these valves.

The pressure relief valve 77 contains a drilled cavity 114 to take a central hydraulic spool 115. The valve body has two ports 116, 117: a high pressure port 116 and a low pressure port 117. In normal apparatus operation, without load, there is no differential pressure across the valve ports 116, 117. In this state, a spring 118 located in the left hand side of the housing and seated in the cavity 114 of the spool 115, forces the spool 115 to remain over to the right hand side of the housing (the high pressure side). In this position the spool 115 closes the low pressure port 117 and no flow is possible. However the high pressure port 116 remains open. The high pressure port 116 also (importantly) contains a small pilot port 119 which allows hydraulic fluid to flow through it and enter a cavity which has been closed off by a piston 120 on the far right hand side of the spool 115.

When load comes on the hydraulic actuator, as previously described, the gear rotation will generate a pressure. Because the high pressure port 116 will see this pressure two things happen simultaneously. Firstly, fluid is forced into the centre of the valve body where it is trapped because the low pressure port 117 is still closed off by the spool land. This entrapment of fluid within the central body of the valve causes no action because the spool 115 has been carefully designed to be centrally hydrostatically balanced—there is no net end thrust either way from central fluid pressure. The second and simultaneous action with the first flow is that high pressure fluid moves up the small pilot channel 119 and now bears against the face of the piston 120 (right hand end of the spool). However balancing this hydraulic force against the piston face 120 is the force of the compressed spring 118 acting against the spool 115 at the other end of the valve housing. Movement of the spool will only occur if the fluid pressure acting over the piston area can overcome the spring force—and hence the pressure relief setting of the valve. Should the pressure trapped against the piston be sufficient to overcome the spring 118 then the spool 115 will move and open up the low pressure port 117 and allow flow. However, the spool 115 will not move if there is a fluid lock generated.

Fluid lock has been handled by two design features. The first feature is that the spring cavity 118 is drained to the low pressure port 117. The second and more subtle feature is that the rear of the tapered land on the right hand side of the spool 115 has small bleed holes which connect with a central hole in the spool. This allows fluid flow internally within the spool to equalise pressures on both end of the spool 115, excluding the piston face. This equalisation of end pressures allows only the piston face to be considered acting against the spring 118.

For safety reasons the pressure relief valve will only operate in an overload circumstance. This could occur because a person did not use a proper harness with an intermediate shock absorbing lanyard and the peak decelerating forces exceed 6 kN (ISO/AS/En) or simply the unit is abused by putting a very heavy load on it. A 6 kN cable force will generate approximately 350 bar peak pressure, forces and therefore pressure higher than this have to be relieved. Nominally the pressure relief would be set to 400-420 bar, or in the embodiment of a burst disc a relieving pressure of between 460 and 510 bar is applicable.

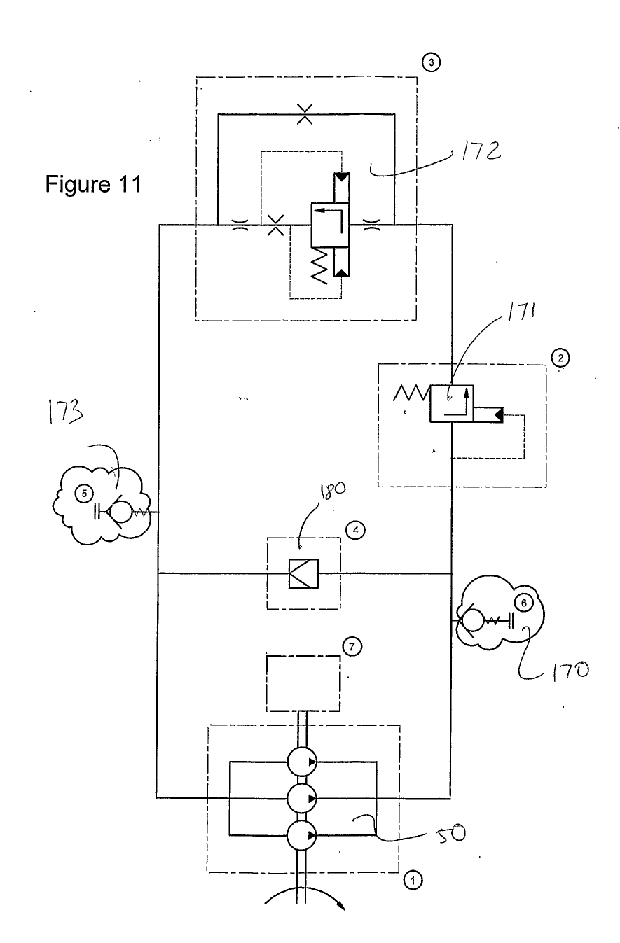

A schematic illustration of a hydraulic circuit using a burst disc valve 180 instead of the pressure relief valve is shown in FIG. 11. The hydraulic actuator 50 is illustrated in the form of a triple planetary hydraulic gear pump. The output of the gear pump has the following components placed in series, namely a vacuum fill valve 170, a hydraulic descent pause valve 171, a hydraulic descent flow control valve 172 and a fill valve 173. A burst disc 180 valve is coupled across the circuit between the downstream side of the fill valve 173 and the downstream side of the vacuum fill valve 170.

The burst disc valve 180 is shown in detail in FIG. 10d. An elongate housing 181 has an inlet port 182 and outlet port 183 joined by a conduit 184. An end plug 185 sealed by an O-ring 186 is positioned in the end of the housing adjacent the outlet port 183. Within the conduit 184 is positioned burst disc assembly 190 that is positioned adjacent two load distribution washers 191, 192 that are positioned coaxially between a series of Belleville preload washers 195.

The whole assembly is held in place by a tapered load nut 199 that is in threaded engagement within the bore of the conduit 181. The burst disc assembly comprises a curved stainless steel diaphragm 196 sandwiched between annular supports 197, 198. The burst disc provides an alternative means of preventing over pressurisation of the hydraulic housing.

The selector valve 75 is a one-shot hydraulic switch. A light spring 122 fits into the housing cavity 123 on the left hand side and acts against a recess 124 in a spool 125 to force it to the right and thereby close the low pressure housing side port 126. This valve is also ported to have a pilot signal act on the right hand side of the valve. However, unlike the pressure relief valve 77, this pilot signal port 130 has a sealing poppet valve 131.

The purpose of the poppet valve 131 is to lift when there is pressure applied and allow high pressure fluid into the cavity on the right hand side of the valve and thereby bear against and push the spool 125 across to uncover the low pressure port 127 and allow flow.

Because it is imperative from a safety view point in descent to maintain flow with possible dynamic loads of a person swinging feeding back to pressure fluctuations, the poppet valve 131 will seat and prevent loss of pilot signal should the pressure be lost due to such a dynamic event. This also works to prevent a stuttering of the hydraulic actuator when it is lightly loaded (e.g. 60 kg person).

The timing and hence the size of the pilot port 130 are important. Prior to a fall occurring, the spool 125 closes the low pressure port 127 and prevents flow. On a fall, pressurised fluid will enter the valve body but do nothing to move the spool 125 because it is hydraulically balanced. Hydraulic fluid will force its way through the pilot channel 130, past the poppet valve 131 and acts to push the spool 125 across. Hydraulic lock is prevented by keeping areas consistent and relieving the rear of the spool spring cavity 123.

The hydrostat valve assembly 76 (FIG. 10e) is the constant flow rate control valve. Its purpose is to provide a constant pressure drop across a needle valve 140 by moving the hydrostat 141 to regulate the pressure upstream of the needle valve 140. A constant pressure drop across the needle valve 140 implies also constant flow rate—fluid incompressibility effects have not been important at typical descent pressures of 80 bar and less. A 140 kg person will require a more closed position of the hydrostat 141 and a 60 kg person will require a more open position of the hydrostat 141. The upstream and downstream pressure generated by flow past the needle valve 140 is fed to both sides of the hydrostat valve via ports internal to the valve body. Both sides of the hydrostat valve 141 are piloted to enable it to sense and correct for a pressure drop across the needle valve 140 (unlike the previous valves 77 and 75 where only one side of the spool was piloted). The hydrostat 141 is located on the high pressure side face (right). It has been angled for space reasons, but the angle has been limited to minimise inertial sensitivity to centripedal accelerations as the hydraulic actuator rotates at speeds of up to 800 rpm. The needle valve 140 is “factory” set to provide the right response to load. A plunger 142 (top left) has no flow control purpose. It has been designed into this valve assembly to enable the system to have a means of handling fluid expansion and contraction with the wide temperature range required for certification (−30° C. to +54° C.). A spring 143 behind the plunger 142 maintains a minimum system pressure unloaded. This is important because fluid shrinkage as temperatures drop can cause a vacuum to develop in the unit and any seal bypassing would permit air to be sucked into the housing. The safety feature afforded by the plunger 142 is to allow a set fluid preload, on filling, so a vacuum does not happen at minimum operating temperature.

The mechanical seal assembly 100 fit within the left hand side of the open housing 57. A short shaft 110 is supported about bearings 102, 103 with a lip seal housing 104 which is bolted to a projecting spigot 105 on the left of the housing 57. The shaft 110 has one (outer) end 106 located in an end cap 107 located centrally of the outer housing 11 and the other end is splined to the sun gear of the hydraulic actuator. A pair of spring loaded seals 108, 109 surround the shaft 110 between the lip seal housing 104 and the sun gear.

The three housings 55, 56, 57 of the hydraulic actuator 50 are each provided with rectangular cut-outs 70, 71, 72 equally spaced in radial extremities. These rectangular cut-outs accommodate respectively a selector valve 75, a hydrostat valve 76 and a pressure release valve 77, details of which are respectively shown in FIGS. 10c, d and e. The central housing 56 is provided with a pair of tapped closed holes 78, 79 on either side of the rectangular cut-outs 70, 71, 72 which hold bolts (not shown) which engage clamps (not shown) that hold the valve assemblies within the respective cut-outs.

An oil pump, similar to the hydraulic actuator 50 described herein, is described in our earlier patent application WO2006/024101, the disclosure of which is incorporated herein by reference. The combination of the approx 1:6 gearbox caused by the epicyclic gear train 90 and the use of three mini-pump pairs in the hydraulic actuator substantially reduces the overall oil pressure which is required in the hydraulic actuator to control the rate of descent. The assembly is designed so it can operate to allow the descent of a human weighing between 60 kg and 141 kg descending at a substantially constant speed of about 0.90 to 1.1 m/second depending on oil viscosity characteristics at temperature. An aviation grade, low pour point, highly refined mineral hydraulic oil, to MIL-PRF-5606H and viscosity index exceeding 360 is typical of the class of fluid required. The hydraulic valve assemblies incorporate a speed control mechanism which ensures a constant controlled speed of descent proportional to the load at the end of the wire rope W.

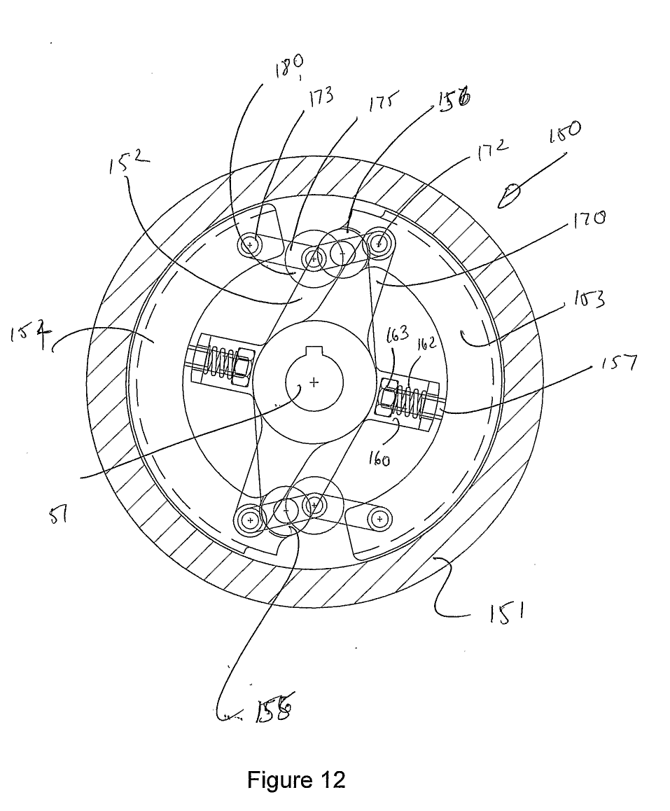

As a further security means, in the event that the input shaft 51 of the hydraulic actuator 50 exceeds a certain speed, required to be 1.7 to 2.0 ms⁻¹, an over-speed centrifugal brake 150 is positioned between the exterior of the shaft 51 and the housing 12 of the device. The centrifugal brake 150 is shown in greater detail in FIG. 12. The outer housing 12 has an axially extending central projection 151 that defines the stationary drum of the brake. The central shaft 51 of the hydraulic actuator 50 extends through the end bearing to be in keyed engagement with a diametrically extending brake shoe support flange 152. A pair of arcuate brake shoes 153, 154 fit within the periphery of the drum 151. Each shoe 153 or 154 is attached to the end of the flange 152 by a pivot point 155, 156. The underside of each shoe 153, 154 supports a radial bolt 157 that extends into a socket 160 that projects radially from the centre of the flange 152. A spring 162 surrounds the bolt 157 and is located thereon by an adjustable nut 163 to draw the shoe 153, 154 away from the interior of the hub 151.

The central shaft 51 has also splined onto it a counterweight flange 170 that is positioned outboard of the shoe support flange 152. The counterweight flange 170 is coupled at each end to one link 172 of a linkage 175. That link 172 is coupled to a counterweight 180 which is, in turn, coupled to the end of the shoe via a link 173 of the linkage 175. In this way, the adjacent ends of the shoes 153, 154 are interconnected through the linkage 175 and counterweight 180.

The adjustable spring loading mechanisms described above is used for the purpose of setting activation speed. The centrifugal brake is designed so it only effectively operates when the speed of descent reaches a predetermined maximum, usually 1.7 m/sec. At this stage, the centrifugal forces cause the shoes 153, 154 to be forced into engagement with the hub 151 to substantially slow down the unit. The counterweight arrangement controls the operation of the shoe and increases the frictional resistance for a given brake diameter. The lagging hinge position on the pivoting brake shoes allows the use of friction to increase the braking effect and reduce the reliance on centrifugal assistance. The brake described above is very space efficient but needs to be carefully balance to ensure that it is not self locking. Limiting the leverage from friction requires compensation by adding the counterweights as described above. The counterweight flange 170 is mounted outboard of the shoe support flange 152 so that the counterweights 155, 156 can be positioned for maximum centrifugal advantage. The position of the counterweight has also been set to give a shallow linkage angle and a higher force multiplication through to the brake shoes 153, 154.

It is the intention of the system described above that it:
(a) has fall arrest capabilities which, when separately considered, are designed to comply with fall arrest codes (ISO 10333-3-2004, AS1891.3-1997, and ANSIZ359.1-1992) in that it is capable of arresting the fall by bringing a person to a controlled stop within the prescribed distances, body force limitations and temperature between −30° C. and +54° C.;
(b) has descent capabilities which, when separately considered, are designed to comply with ISO 22159-2007 Type 1D for descent devices;
(c) combines these separate features so that, following the arresting of the fall, the person is then involuntarily lowered to a load bearing surface, conscious or otherwise, at a controlled descent speed factoring in a weight range of 60 kg to 141 kg and changes in spooled rope diameter that occur during descent; and
(d) provides for a redundant braking system, which also permits continued descent, in the unlikely event of a primary system over speed or hydraulic failure.

On falling, a person connected to the wire lifeline forces the pulley to accelerate to a speed at which the male side of the centrifugal clutch engages the female side. The female side of the centrifugal clutch is connected to three planetary gears. The planetary gears are in turn meshed between an annulus gear (outer) and sun gear (inner). Because the annulus gear is fixed into the housing, the planetary gears are forced to rotate the sun gear. The sun gear resists rotation by virtue of the sudden inertial resistance and then later hydraulic resistance provided by the central hydraulic braking actuator. The resistance to rotation (torque) provided by the hydraulic actuator feeds back through the epicyclic gear train, centrifugal clutch and pulley assembly to arrest the payout of the wire life line and thereby prevent an uncontrolled and rapid descent of the person. With reference back to the sun gear, it drives two brake systems, the hydraulic actuator and centrifugal brake. These braking systems are both in line. The hydraulic actuator is a low speed descent control unit (1 ms⁻¹) and the centrifugal brake is an over speed protection device, needing to operate if the payout speed reaches in excess of 1.7 to 2.0 ms⁻¹. This descent speed could be envisaged if hydraulic failure occurred due to, for example, O-ring rupture, rotating seal failure or burst disc failure. In normal descent operation the centrifugal braking system rotates with the hydraulic actuator but does not reach sufficient speed to frictionally engage the housing.

The hydraulic actuator comprises; a closed circuit pump, a sealed hydraulic fluid reservoir, and three specially designed spool operating valves. These spool valves are; a counterbalance valve which acts to relieve system over pressure internally, an arrest/descent selector valve for handling the transition between fall arrest and subsequent descent, and a hydrostat valve for constant flow rate control once the selector valve permits flow.

In the preferred embodiment shown in the drawings, the hydraulic actuator 50 is located within a cavity in the interior of the pulley 15. In another embodiment not shown in the drawings, the hydraulic actuator can be housed within a cavity formed as part of the housing 11 or 12. The advantage of putting the hydraulic actuator into the housing means that the reaction forces that flow through the hydraulic actuator are absorbed by the robust structure of the housing and are taken off the central shaft 51.

In normal use, with a working person connected to the unit but standing on the current working elevation, the sheave simply rotates around the hydraulic unit and the centrifugal clutch remains disengaged. The tension spring is connected to the pulley and this provides a subtle back tension to prevent a fall occurring on a slack cable. The back tension is pre-adjusted to meet the code requirements for use.

The fall protection system disclosed above, whilst specifically designed for use in building sites and other industrial applications, can be utilised in many other environments such as with cranes and gantries, helicopters and natural height environments such as mountains, cliffs, precipices, etc.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A fall protection system comprising a line wound onto a rotatable pulley having a centrifugal clutch which activates a gearbox which in turn drives an input shaft of a hydraulic actuator whereby the hydraulic actuator controls the rate of rotation of the pulley, and a secondary brake which slows the rotational speed of the pulley should it exceed a predetermined speed, whereby in use, the line is attached to a user to restrain a fall and then the system facilitates unwinding of the line at a controlled speed to effect descent.

2. The fall protection system according to claim 1, wherein the pulley is rotatable about the hydraulic actuator, the input of the actuator being coupled to the pulley via the gearbox and the centrifugal clutch.

3. The fall protection system according to claim 1, wherein the gearbox comprises an arm driven by the centrifugal clutch through an epicyclic gear train.

4. The fall protection system according to claim 3, wherein the gearbox effects a torque reduction of approximately 6:1 thereby permitting lower hydraulic pressures to be realised at peak fall arrest forces.

5. The fall protection system according to claim 1, wherein the hydraulic actuator contains a closed circuit gear pump including a central sun gear that meshes with planetary gears.

6. The fall protection system according to claim 5, wherein the sun gear meshes with three planetary gears equally spaced around its periphery.

7. The fall protection system according to claim 6, wherein the sun and planetary gears are rotatably sandwiched between members which include a series of orifices and cavities and interconnecting channels through which hydraulic fluid for the hydraulic circuit is pumped through the closed circuit gear pump.

8. The fall protection system according to claim 1, wherein the hydraulic actuator comprises an oil pump with flow and pressure control valving.

9. The fall protection system according to claim 1, wherein the secondary brake comprises brake shoes driven by centrifugal forces against a drum secured to or forming part of the housing.

10. The fall protection system according to claim 9, wherein the brake shoes are pivotally secured to a radially extending support arm driven by the input shaft.

11. The fall protection system according to claim 10, wherein counterweights are mounted on a radially extending support flange driven by the input shaft, the counterweights being pivotally secured to both brake shoes via a linkage.

12. The fall protection system according to claim 9, wherein a spring loaded adjustment means pulls each brake shoe away from the drum.

13. The fall protection system according to claim 1, wherein the pulley unwinds against a spring which causes the line to rewind after descent.
